(19) United States
(12) Patent Application Publication
(10) Pub. No.: US 2022/0405699 A1
(43) Pub. Date: Dec. 22, 2022

(54) ORDER SUPPORT SYSTEM, ORDER SUPPORT METHOD, AND NON-TRANSITORY COMPUTER-READABLE STORAGE MEDIUM

(71) Applicant: TOYOTA JIDOSHA KABUSHIKI KAISHA, Toyota-shi (JP)

(72) Inventors: Nobuhisa OTSUKI, Toyota-shi (JP); Haeyeon LEE, Tokyo-to (JP); Yutaro TAKAGI, Tokyo-to (JP); Yuta ITOZAWA, Nagoya-shi (JP); Hirotaka KOMURA, Tokyo-to (JP); Kunihiro IWAMOTO, Nagakute-shi (JP); Kota OISHI, Yokohama-shi (JP)

(73) Assignee: TOYOTA JIDOSHA KABUSHIKI KAISHA, Toyota-shi (JP)

(21) Appl. No.: 17/831,582

(22) Filed: Jun. 3, 2022

(30) Foreign Application Priority Data
Jun. 21, 2021 (JP) 2021-102707

(51) Int. Cl. G06Q 10/08; G06K 7/10

(52) U.S. Cl. CPC G06Q 10/087; G06K 7/10297; G06K 7/10099

(57) ABSTRACT

The order support system includes an information acquisition apparatus for acquiring position information, which is an indicator of a position of a target item whose remaining quantity gradually decreases due to repeated consumption, using near field communication, and at least one processor that is configured to perform support control for automatically ordering the target item based on the position information. The information acquisition apparatus includes an identification tag attached to the target item, and a reader to read the unique information stored in the identification tag. The at least one processor is configured to execute calculating a remaining quantity index value which is an index of the remaining quantity of the target item, based on the position information, and transmitting order information of the target item based on the remaining quantity index value.

### CROSS-REFERENCE TO RELATED APPLICATION

The present application claims priority under 35 U.S.C. § 119 to Japanese Patent Application No. 2021-102707, filed Jun. 21, 2021, the contents of which application are incorporated herein by reference in their entirety.

### BACKGROUND

### Field

The present disclosure relates to a technique of an order support system that automatically place orders for target items.

### Background

JP2018-41234A discloses techniques relating to a management system for medical materials. The management system of this technology includes a management server and an inventory storage device for storing medical materials with IC tags attached. The management server receives the stored information of the IC tag that was read when the medical material was removed from the inventory storage device. The management server records the read stored information with the used status.

### SUMMARY

Consider managing items whose remaining quantity gradually decreases due to repeated consumption. Items that are used repeatedly are generally returned to their original position after use. In the technique of JP2018-41234A described above, it is not assumed that the medical material once removed from the inventory storage device is returned again into the inventory storage device. As described above, in the technique of JP2018-41234A, management of ordering arrangements and the like has not been considered for a item whose remaining quantity gradually decreases due to repeated consumption.

The present disclosure has been made in view of the above-mentioned problems, and an object thereof is to provide a technique capable of supporting the placing orders of items whose remaining quantity gradually decreases due to repeated consumption.

The present disclosure provides an order support system for achieving the above object. The order support system according to the present disclosure includes an information acquisition apparatus and at least one processor. The information acquisition apparatus acquires position information, which is an indicator of a position of a target item whose remaining quantity gradually decreases due to repeated consumption, using near field communication. The at least one processor is configured to communicate with the information acquisition apparatus and perform support control for automatically ordering the target item based on the position information. In the support control, the at least one processor is configured to execute calculating a remaining quantity index value which is an index of the remaining quantity of the target item, based on the position information, and transmitting order information of the target item based on the remaining quantity index value.

In the order support system according to the present disclosure, the information acquisition apparatus may include an identification tag attached to the target item and stored unique information to identify the target item, and a reader to read the unique information stored in the identification tag using the near field communication.

Further, the remaining quantity index value may be a movement count the target item has moved. In the support control, the at least one processor may be configured to execute transmitting the order information of the target item when the movement count exceeds a predetermined reference count. Alternatively, the remaining quantity index value may be the movement count the target item has moved. In the support control, the at least one processor may be configured to execute notifying an order permission request to user when the movement count exceeds a predetermined reference count, transmitting order information for the target item upon receipt of an order permission for the order permission request, and correcting the reference count to an incremental side when the order permission for the order permission request is not received.

In addition, the reader may include a gate reader provided so as to straddle a middle of a moving route from a first area in which the target item is stored to a second area in which the target item is consumed. Alternatively, the reader is positioned to read the identification tag in a state in which the target item is positioned in a predetermined storage area.

Further, for achieving the above object, the present disclosure provides an order support method for supporting an order of a target item whose remaining quantity gradually decreases due to repeated consumption. The method includes acquiring position information, which is an indicator of a position of a target item by using near field communication, calculating a remaining quantity index value which is an index of the remaining quantity of the target item, based on the position information; and transmitting order information of the target item based on the remaining quantity index value.

Furthermore, for achieving the above object, the present disclosure provides a non-transitory computer-readable storage medium storing an order support program. The order support program is a program causing a computer to support an order of a target item whose remaining quantity gradually decreases due to repeated consumption. The order support program is configured to cause a computer to execute acquiring position information, which is an indicator of a position of a target item by using near field communication, calculating a remaining quantity index value which is an index of the remaining quantity of the target item, based on the position information, and transmitting order information of the target item based on the remaining quantity index value.

According to the technique of the present disclosure, the position information of the target item is acquired by the information acquisition apparatus. When the position of the target item changes, there is a high probability that the target item is consumed. Therefore, according to the present disclosure, it is possible to calculate a remaining quantity index value, which is an index of the remaining quantity of the target item, based on the position information. As a result, the order information can be transmitted by appropriately determining the ordering timing of the target item, so that it is possible to appropriately support placing the orders of items whose remaining quantity gradually decreases due to repeated consumption.

### BRIEF DESCRIPTION OF DRAWINGS

FIG. 1 is a configuration diagram of an order support system according to a first embodiment of the present disclosure;

FIG. 2 is a block diagram showing an example of the configuration of the order support system;

FIG. 3 is a functional block diagram showing functions realized by executing a program by a processor of a management server;

FIG. 4 is a diagram showing an example of item management information stored in a memory;

FIG. 5 is a diagram showing a specific operation example of placing an order for a item by the order support system;

FIG. 6 is a flowchart of a routine executed in a count processing;

FIG. 7 is a flowchart of a routine executed in the determination processing and the order processing in the order support system according to the first embodiment;

FIG. 8 is a diagram showing another operation example of placing an order for a item by the order support system; and

FIG. 9 is a flowchart of a routine executed in the determination processing and the order processing in the order support system according to a second embodiment.

### DETAILED DESCRIPTION

Hereinafter, an embodiment of the present disclosure will be described with reference to the accompanying drawings. However, it is to be understood that even when the number, quantity, amount, range, or other numerical attribute of each element is mentioned in the following description of the embodiment, the present disclosure is not limited to the mentioned numerical attribute unless explicitly described otherwise, or unless the present disclosure is explicitly specified by the numerical attribute theoretically.

### 1. First Embodiment

### 1-1. Summary of Order Support System

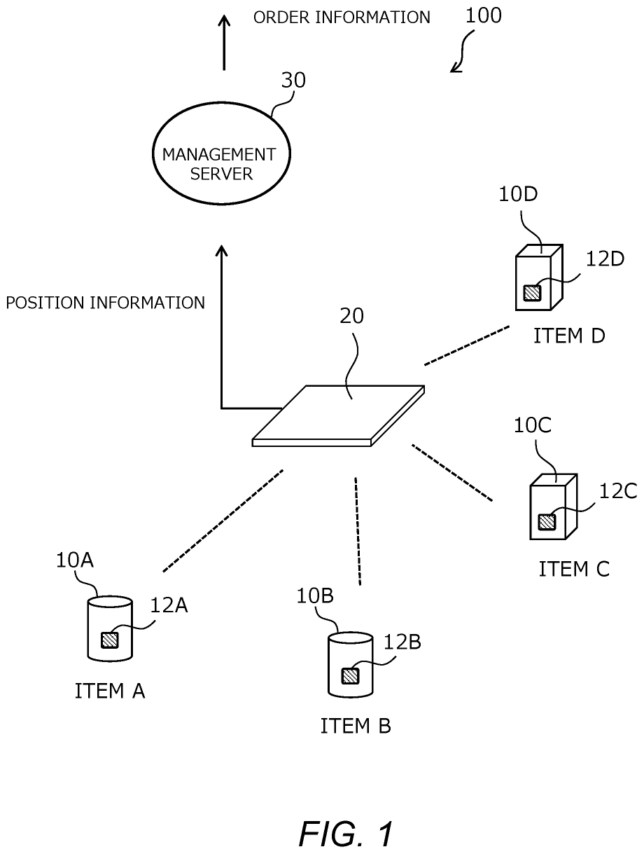

FIG. 1 is a configuration diagram of an order support system according to a first embodiment of the present disclosure. An order support system 100 is intended for items whose remaining quantity gradually decreases due to repeated consumption, and whose use involves movement. Examples of such target items include seasonings consumed by moving between a kitchen and a dining place, pet foods consumed by moving between a storage place and a breeding place, and the like.

The order support system 100 includes an identification tag 12 attached to a target item 10, a reader 20, and a management server 30. The identification tag 12 is, for example, a passive RFID tag in which unique information for identifying the target item 10 is embedded, and is attached to the target item 10 in advance. FIG. 1 illustrates an example in which identification tags 12A, 12B, 12C, 12D in which different pieces of unique information (ID information) are embedded are attached to target items 10A, 10B, 10C, 10D.

The reader 20 is a reader to read unique information from the identification tag 12 in close proximity by using near field communication. The form of the reader 20 is not limited. The reader 20 can be, for example, a reader of a known form, such as a gate-type reader that receives unique information from the identification tag 12 passing through the gate, a flat plate-type reader that receives unique information from the identification tag 12 in close proximity, a box-type reader that receives unique information from the identification tag 12 in the container, or the like.

When the unique information of the identification tag 12 is received by the reader 20, it indicates that the target item 10 to which the identification tag 12 is attached is located in a reception range of the reader 20. On the other hand, when the unique information of the identification tag 12 is not received by the reader 20, it indicates that the target item 10 to which the identification tag 12 is attached is located outside the reception range of the reader 20. That is, the reception state of the unique information received by the reader 20 can be used as position information serving as an index of the position of the target item 10.

In the order support system 100 of the present embodiment, the reader 20 is arranged at a position where a change occurs in the reception state of the unique information in accordance with the movement of the target item 10 during use. For example, if the reader 20 is a gate-type reader, the reader 20 can be arranged so as to straddle a movement path of the target item 10 that is moved for consumption. Alternatively, if the reader 20 is a flat plate-type reader or a box-type reader, the reader 20 can be arranged in a storage area of the target item 10. According to such an arrangement, when the presence or absence of the reception of the unique information received by the reader 20 changes, it can be determined that the target item 10 has been moved for use. The unique information read by the reader 20 is transmitted to the management server 30 via a communication network.

The management server 30 performs support control for supporting the placing order of the target item 10 based on the position information. The management server 30 may be directly connected to the reader 20 in a facility or may be connected from a remote location via a communication network.

The management server 30 stores the reception state of the unique information as position information associated with the unique information of the target item 10. In the support control, the management server 30 counts a movement count C of the target item 10 each time the movement of the target item 10 is determined from the position information. This calculation processing is hereinafter referred to as “count processing”.

As the movement count C increases, the probability that the target item 10 is consumed increases. That is, the movement count C is a remaining quantity index value serving as an index of the remaining quantity of the target item 10. Therefore, in the support control, when the movement count C exceeds a predetermined reference count Cth, the management server 30 determines that the next order of the target item 10 is necessary. This processing is hereinafter referred to as “determination processing”. The reference count Cth is a determination value for determining that the remaining quantity of the item has been decreased to a level requiring ordering. The management server 30 stores the reference count Cth of each target item 10 in association with each piece of unique information. The reference count Cth may be a fixed value set for each target item 10, or the user may set an arbitrary number of times.

In the support control, when the movement count C exceeds the reference count Cth, the management server 30 places an order for the target item 10. This processing is hereinafter referred to as “order processing”. In the order processing, the management server 30 generates order information of the target item 10. The order information includes information such as unique information, quantity, order destination, and the like of the target item 10. The management server 30 transmits the order information to the order destination via the communication network.

According to the order support system 100 as described above, it is possible to determine the remaining quantity of the target item 10 by counting the movement count C of the target item 10 using the identification tag 12 and the reader 20. This makes it possible to automatically place an order for the target item 10 at an appropriate timing.

### 1-2. Configuration of Order Support System

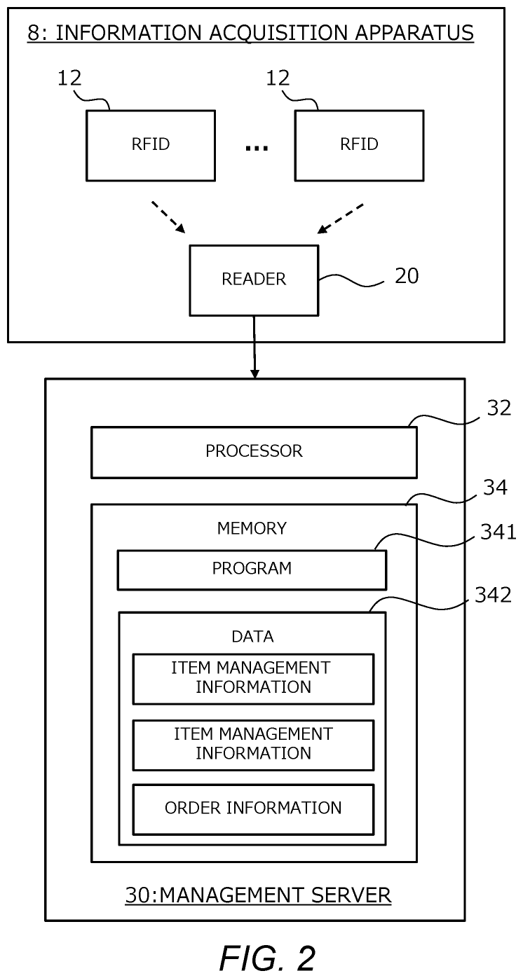

FIG. 2 is a block diagram showing an example of the configuration of the order support system. The order support system 100 includes an information acquisition device 8 and a management server 30. The information acquisition device 8 includes the identification tag 12 and the reader 20 described above. The identification tag 12 is attached to each of one or a plurality of target items 10. Each of the identification tag 12 stores the unique information of the corresponding target item 10.

The management server 30 includes a function of a processing device as a computer. Typically, the management server 30 includes one or more processors 32 (hereinafter simply referred to as processor 32) and one or more memories 34 (hereinafter simply referred to as memory 34) coupled to processor 32. The memory 34 stores one or more order support programs 341 executable by the processor 32 (hereinafter, simply referred to as a program 341) and various data 342 associated therewith.

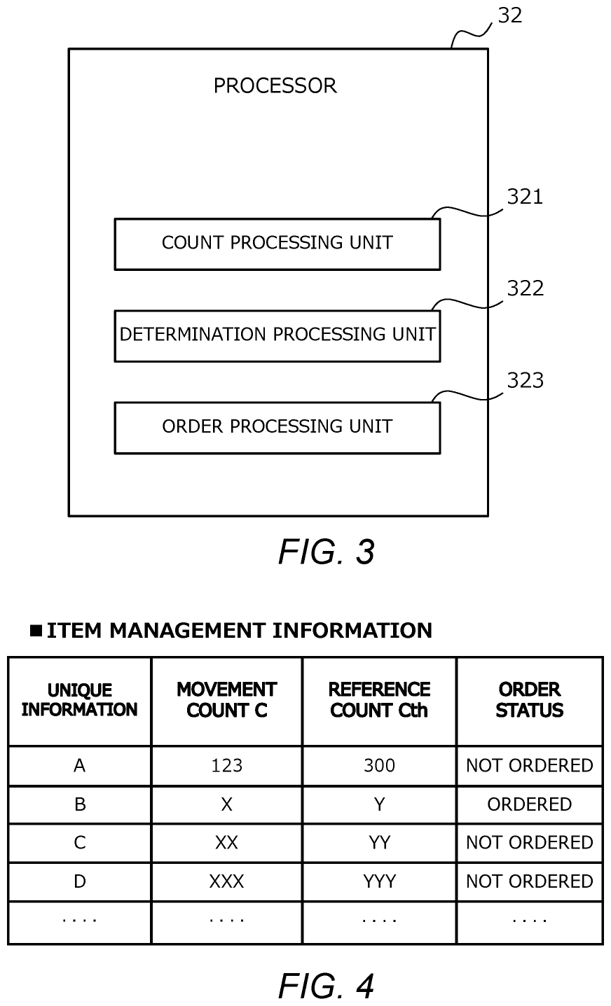

The processor 32 executes the order support program 341, various processing by the processor 32 is realized. FIG. 3 is a functional block diagram showing functions realized by executing a program 341 by a processor of a management server 30. As shown in FIG. 3, the processor 32 includes a count processing unit 321 for performing count processing of the target item 10, a determination processing unit 322 for performing determination processing of order necessity of the target item 10, and an order processing unit 323 for performing order processing of the target item 10. The function of the processor 32 will be described below, referring also to FIG. 1, with reference to a case in which the management server 30 automated orders the target item 10.

The count processing unit 321 is a functional block having a function of counting the movement count C of the target item 10 based on the position information. The position information is the unique information of the identification tag 12 read by the reader 20. The memory 34 stores a read state of the unique information transmitted from the reader 20 as the position information. The count processing unit 321 increments the movement count C upon receiving that the read state of the unique information included in the position information has changed from ON to OFF or from OFF to ON. The movement count C is stored in the memory 34 as item management information.

FIG. 4 is a diagram showing an example of the item management information stored in the memory. In the item management information, the movement count C, the reference count Cth, and the order status are stored in association with the unique information of the target item 10. The movement count C is updated every time it is incremented by the count processing. The order status is status information indicating whether the target item 10 has been ordered. A status indicating that an order has been placed is attached to the target item for which the order processing has been performed in the order processing.

The determination processing unit 322 is a functional block for determining whether the movement count C exceeds the reference count Cth. The reference count Cth is read a value stored in advance as the movement count where the remaining quantity of the target item 10 becomes a quantity that requires ordering.

The order processing unit 323 is a functional block that generates order information of the target item 10 when the determination processing unit 322 determines that the movement count C exceeds the reference count Cth. The generated order information is stored in the memory 34, and transmitted to the order destination at a predetermined timing.

### 1-3. Specific Example of Placing Order for Item by Order Support System

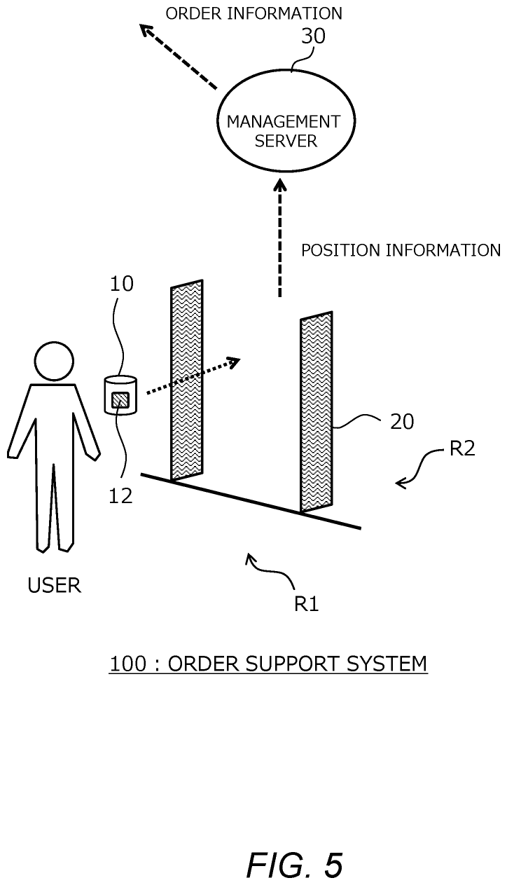

Next, an operation example of placing an order for a item by the order support system 100 according to the first embodiment will be described with reference to FIG. 5. The order support system 100 is a system for automatically placing an order for a target item when the remaining quantity of the item is decreases. FIG. 5 is a diagram showing a specific operation example of placing an order for a item by the order support system. In the example shown in FIG. 5, a system user in the facility carries the target item 10 from the first area R1 to the second area R2 for the purpose of using the target item 10. Typically, the first area R1 is a kitchen area, the second area R2 is a dining area, and the target item 10 is a seasoning. The reader 20 is a gate-type reader. The reader 20 is arranged so as to straddle the middle of the path traveling from the first area R1 to the second area R2.

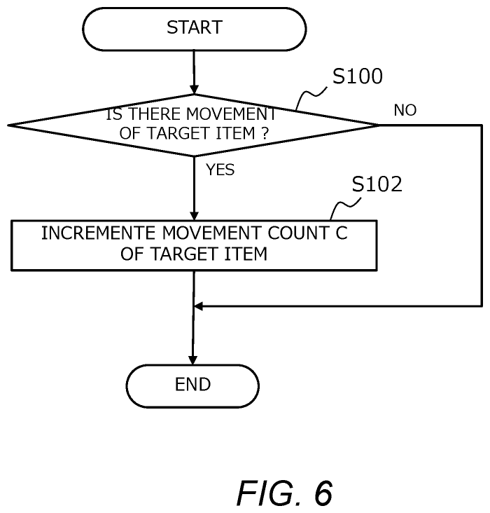

The management server 30 executes count processing for counting the movement count C of the target item 10. FIG. 6 is a flowchart of a routine executed in the count processing. The routine shown in FIG. 5 is repeatedly executed at a predetermined control cycle in the processor 32 of the management server 30 for each of one or a plurality of target items 10. The flowchart also represents a part of the order support method according to the first embodiment of the present disclosure.

When the user passes through the reader 20 with the target item 10, the reader 20 reads the unique information of the identification tag 12 attached to the target item 10. The read unique information is transmitted to the management server 30 as the location information of the target item 10.

In step S100, the processor 32 determines whether there is a movement of the target item 10 based on the received position information. Here, the processor 32 determines whether the read state of the unique information included in the position information is switched from ON to OFF or from OFF to ON. As a result, when the read state of the unique information is not switched, this routine is terminated, and when the read state of the unique information is switched, the processing proceeds to step S102.

In step S102, the processor 32 increments the movement count C of the target item 10 and updates the movement count C of the item management information.

When the movement of the target item 10 is repeated, the remaining quantity of the target item 10 gradually decreases. The management server 30 execute a determination process for determining an appropriate ordering time of the target item 10 and an order processing for ordering the target item 10.

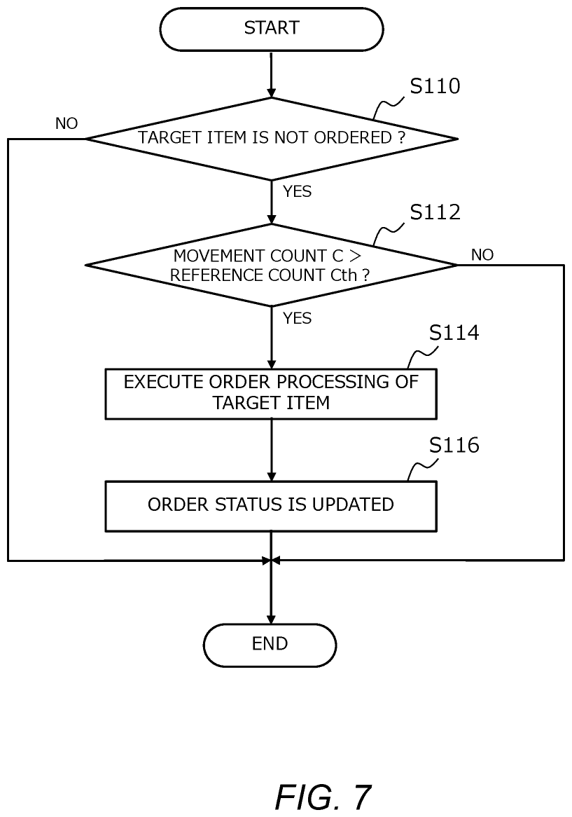

FIG. 7 is a flowchart of a routine executed in the determination processing and the order processing. The routine shown in FIG. 7 is repeatedly executed at a predetermined control cycle in the processor 32 of the management server 30 for each one or more kinds of target items 10. The flowchart also represents a part of the order support method according to the first embodiment of the present disclosure.

In step S110, the processor 32 determines whether the target item 10 is not ordered. Here, the processor 32 determines whether the order status of the target item 10 stored in the item management information is “not ordered”. As a result, when the order status of the target item 10 is “ordered”, this routine is terminated, when the order status is “not ordered”, the process proceeds to step S112.

In the step S112, the processor 32 determines whether the movement count C exceeds the reference count Cth. Here, the movement count C and the reference count Cth of the target item 10 stored in the item management information are read, and the magnitudes thereof are compared. As a result, when the movement count C>the reference count Cth is not satisfied, it is determined that the remaining quantity of the target item 10 is sufficient, and the present routine is terminated.

On the other hand, in step S112, when the movement count C>the reference count Cth is satisfied, it is determined that the remaining quantity of the target item 10 is small, and the process proceeds to step S114. In the step S114, the processor 32 executes the order processing of the target item. Here, the processor 32 generates the order information of the target item 10, and transmits the order information to the order destination via the communication network. When the processing of step S112 is completed, the processing proceeds to step S116. In step S116, the order status of the item management information of the item management information of the item 10 for which the order processing has been executed is updated to the ordered status of the item management information. When the process of step S116 is completed, this routine is terminated.

As is apparent from the above description, according to the order support system 100 according to the first embodiment, the remaining quantity of the target item can be grasped from the movement history of the target item, and the order can be automatically placed at an appropriate timing. As a result, it is possible to save the time and effort for the user to check the remaining quantity of the target item and place an order by himself/herself.

### 1-4. Modified Examples

The order support system 100 according to the first embodiment may be modified as described below.

### 1-4-1. Reader 20

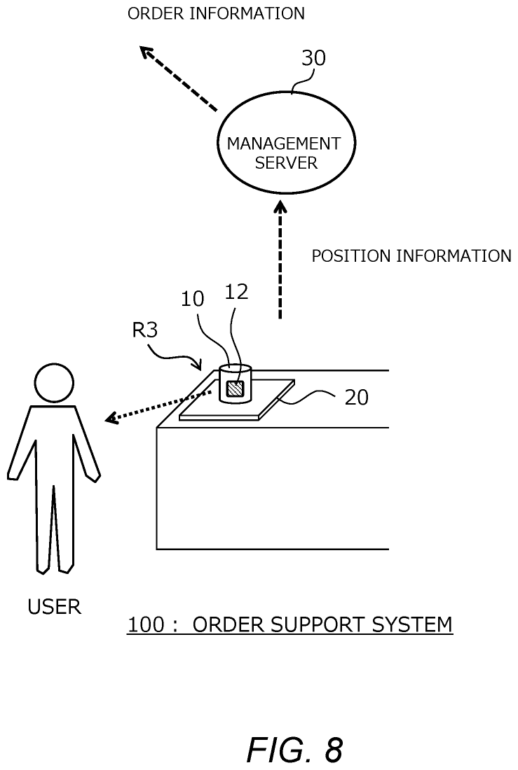

The arrangement of the reader 20 is arranged is not limited to the gate-type reader shown in FIG. 5. FIG. 8 is a diagram showing another operation example of placing an order of items by the order support system. In the example shown in FIG. 8, a flat plate-type reader 20 is arranged on the bottom surface of a storage area R3 of the target item 10. Typically, the storage area R3 is a seasoning storage place, and the target item 10 is a seasoning. When the target item 10 is a item requiring refrigeration, the storage area R3 may be in the refrigerator. The target item 10 is placed on the reader 20 in the stored state. According to such a configuration, the reader 20 always receives the unique information in the stored state of the target item 10. When the user takes the target item 10 for the purpose of use, the reception state by the reader 20 is switched from ON to OFF. In this manner, it is possible to count the movement count C of the target item 10 by the flat reader 20.

The reader 20 arranged in the storage area R3 may be a box-type reader arranged so as to cover the storage area R3. Also in such a configuration, the movement count C of the target item 10 can be counted by the same operation as that of the flat plate-type reader 20.

### 1-4-2. Identification Tag 12

The identification tag 12 is not limited to a passive-type RFID tag, but may be an active-type RFID tag.

### 1-4-3. Information Acquisition Apparatus 8

The information acquisition apparatus 8 may be an in-facility positioning device based on UWB (Ultra Wide Band). In this case, a reception-only tag for receiving a UWB signal may be attached to the target item 10, and a plurality of sensors for transmitting the UWB signal may be installed in the facility. Even with such a configuration, it is possible to acquire the position information of the target item 10.

### 1-4-4. Determination Processing

The consumption amount of the target item 10 in one movement differs depending on the number of family members or the consumption tendency. Therefore, the reference count Cth used in the determination processing may be set or selected by the user himself/herself. Typically, the user may directly input the value of the reference count Cth. Alternatively, the user may select the value of the reference count Cth from among the plurality-step values. According to such a configuration, it is possible to adjust the relationship between the number of times of movement of the target item 10 and the remaining quantity in accordance with the consumption tendency of the user.

The processor may further estimate the remaining quantity of the target item 10 from the movement count C. In this instance, in the process of the step S122, the reference remaining quantity for which the order is required may be used instead of the reference count Cth.

### 2. Second Embodiment

### 2-1. Features of Second Embodiment

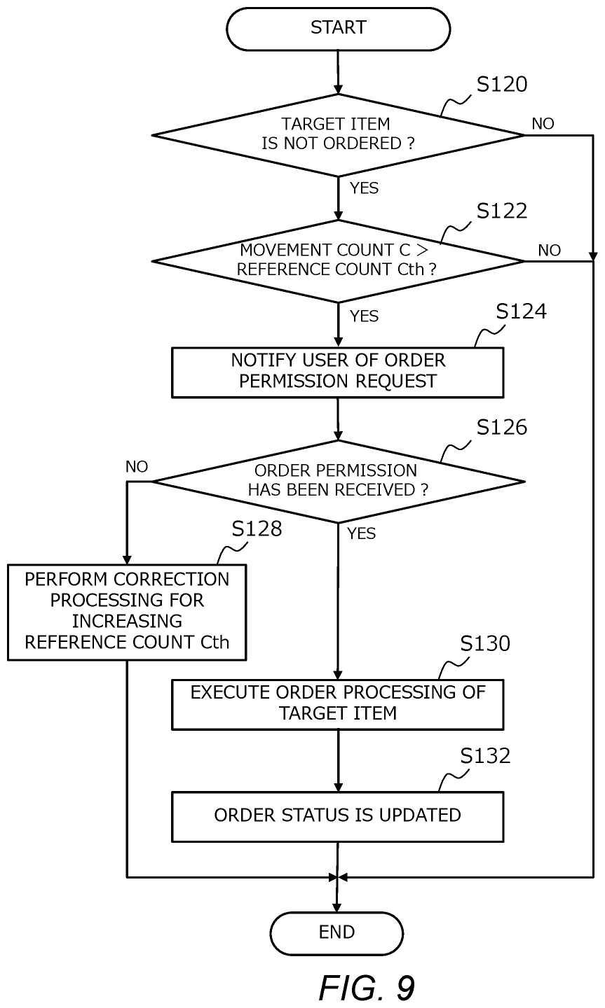

Next, the order support system according to the second embodiment of the present disclosure will be described. The second embodiment is characterized in that the reference count Cth is learned in accordance with the consumption amount of the target item by the user. Hereinafter, in the order support system according to the second embodiment, the flow of the determination processing and the order processing including a learning processing of the reference count Cth will be described with reference to FIG. 9.

FIG. 9 is a flowchart of a routine executed in the determination processing and the order processing in the order support system according to the second embodiment. The routine shown in FIG. 9 is repeatedly executed at a predetermined control cycle in the processor 32 of the management server 30 for each one or more kinds of target items 10.

In step S120 and step S122, the same processing as the processing of step S110 and step S112 in the routine of FIG. 7 is performed. In the process of step S122, when the movement count C>the reference count Cth is not satisfied, the present routine is terminated, and when the movement count C>the reference count Cth is satisfied, the process proceeds to step S124. In the step S124, the processor 32 notifies the user of the order permission request. The order permission request is a request for permission to place an order for the target item 10. The form of notification of the order permission request is not limited. The notification of the order permission request may use, for example, a notification function of an application of a smartphone, or may be a notification using an e-mail or a notification to an interface in a room. When the processing of step S124 is completed, the processing proceeds to step S126.

Upon receiving the order permission request, the user checks the remaining quantity of the target item 10 and determines whether the order permission request is acceptable or not. In step S126, it is determined whether an order permission of the user for the order permission request has been received. For example, the order permission here may be sent using a transmission function of an application of a user's smartphone. As a result, when the order permission of the user is not received, it can be determined that the remaining quantity of the target item 10 is sufficient. In this instance, the processing proceeds to step S128. On the other hand, when the order permission of the user is received, it can be determined that the remaining quantity of the target item 10 is small. In this instance, the processing proceeds to step S130.

In step S128, the processor 32 performs a correction processing for increasing the reference count Cth. Here, the processor 32 updates the reference number Cth stored in the item management information to a value obtained by incrementing a predetermined number of times.

In step S130 and subsequent step S132, the same processes as in step S114 and step S116 shown in FIG. 7 are performed.

As is apparent from the above description, according to the order support system 100 of the second embodiment, even when the movement count C exceeds the reference count Cth, if the user determines that there is a remaining quantity of the target item, the reference count Cth is subjected to the increase correction. By repeating such processing, the reference count Cth is learned to an appropriate number of times for which the order placement is required.

### 2-2. Modified Examples

The order support system 100 according to the second embodiment may be modified as described below.

The processor 32 may periodically prompt the user to measure the weight of the target item 10. The user measures the weight of the target item 10 using a scale. When the scale is connected to the management server 30 via the communication network, the measurement result is transmitted from the scale to the management server 30, or the measurement result is directly input by the user. The processor 32 compares the remaining quantity estimated from the current movement count C with the remaining quantity estimated from the measurement result of the weight, and corrects the reference count Cth. Also, by such processing, the reference count Cth can be learned at an appropriate number of times that the order is required.

What is claimed is:

1. An order support system comprising:
an information acquisition apparatus for acquiring position information, which is an indicator of a position of a target item whose remaining quantity gradually decreases due to repeated consumption, using near field communication; and
at least one processor that is configured to communicate with the information acquisition apparatus and perform support control for automatically ordering the target item based on the position information,
wherein, in the support control, the at least one processor is configured to execute:
calculating a remaining quantity index value which is an index of the remaining quantity of the target item, based on the position information; and
transmitting order information of the target item based on the remaining quantity index value.

2. The order support system according to claim 1,
wherein, the information acquisition apparatus includes:
an identification tag attached to the target item and stored unique information to identify the target item; and
a reader to read the unique information stored in the identification tag using the near field communication.

3. The order support system according to claim 2,
wherein the remaining quantity index value is a movement count the target item has moved, and
wherein, in the support control, the at least one processor is configured to execute transmitting the order information of the target item when the movement count exceeds a predetermined reference count.

4. The order support system according to claim 2,
wherein the remaining quantity index value is movement count the target item has moved, and
wherein, in the support control, the at least one processor is configured to execute:
notifying an order permission request to user when the movement count exceeds a predetermined reference count;
transmitting order information for the target item upon receipt of an order permission for the order permission request; and
correcting the reference count to an incremental side when the order permission for the order permission request is not received.

5. The order support system according to claim 2,
wherein the reader includes a gate reader provided so as to straddle a middle of a moving route from a first area in which the target item is stored to a second area in which the target item is consumed.

6. The order support system according to claim 2,
wherein the reader is positioned to read the identification tag in a state in which the target item is positioned in a predetermined storage area.

7. An order support method for supporting an order of a target item whose remaining quantity gradually decreases due to repeated consumption, the method comprising:
acquiring position information, which is an indicator of a position of the target item by using near field communication;
calculating a remaining quantity index value which is an index of the remaining quantity of the target item, based on the position information; and
transmitting order information of the target item based on the remaining quantity index value.

8. A non-transitory computer-readable storage medium storing an order support program, the order support program being a program causing a computer to support an order of a target item whose remaining quantity gradually decreases due to repeated consumption,
wherein the order support program is configured to cause a computer to execute:
acquiring position information, which is an indicator of a position of a target item by using near field communication;
calculating a remaining quantity index value which is an index of the remaining quantity of the target item, based on the position information; and
transmitting order information of the target item based on the remaining quantity index value.
